(19) United States
(12) Patent Application Publication
(10) Pub. No.: US 2017/0239826 A1
(43) Pub. Date: Aug. 24, 2017

(54) Manual Razor Having Diagonally Positioned Blades

(71) Applicant: Dariusz Dudkiewicz, Buffalo Grove, IL (US)

(72) Inventor: Dariusz Dudkiewicz, Buffalo Grove, IL (US)

(21) Appl. No.: 15/435,783

(22) Filed: Feb. 17, 2017

Related U.S. Application Data
(60) Provisional application No. 62/296,939, filed on Feb. 18, 2016.

(51) Int. Cl. B26B 21/28; B26B 21/22; B26B 21/44

(52) U.S. Cl. CPC B26B 21/28; B26B 21/443; B26B 21/22

(57) ABSTRACT

A manual razor having a handle, a razor blade head, and one or more razor blades is disclosed. The razor blades are oriented at an angle which is diagonal with respect to the edges of the razor blade head and the direction of motion of the blades when in use. Preferably, the blades are parallel to one another and oriented at or substantially at a 45 degree angle. The blades are preferably evenly spaced apart. A horizontal trimming blade is disposed at the top of the razor blade head. Optionally, a moisturizing strip is included at the upper edge of the razor blade head.

### CROSS-REFERENCES

This application claims the benefit of U.S. Provisional Patent Application No. 62/296,939 filed on Feb. 18, 2016, which is hereby incorporated by reference in its entirety.

### BACKGROUND OF THE INVENTION

1. Field of the Invention

The present invention manual razors, and more particularly, to a manual razor structure having one or more slanted blades.

2. Background

Numerous structures for razors have been disclosed and used by the public. Manual razors generally include a handle and a razor head. The razor head includes one or more razor blades.

Typically, razor blades are oriented parallel to the top and bottom edges of the razor head. The razor head is generally oriented such that the top and bottom edges of the razor head are perpendicular to the handle. Thus, in use, the sharp razor blade edge moves in such a way that it is oriented perpendicular to the direction of motion.

While this orientation of the blades in conventional razor heads produces the result of a shave, it is not ideal. This conventional orientation is inefficient, can cause unwanted cuts in the skin, and produces more wear and tear on the blades than is necessary resulting in blades requiring replacement more frequently.

Certain structures have been proposed, such as U.S. Application No. 2003/0182802 filed by Vega et al. Vega et al. disclose a razor head having V-shaped blades. However, the entire cartridge head is V-shaped, making it difficult to control the placement of the razor on the face or other body part. Furthermore, it is difficult to manufacture such a head, and it does not fit with conventional parts.

U.S. Pat. No. 4,663,843 issued to Savage discloses a razor with angled blades. The blades are at different angles with respect to one another. Thus, shaving is accomplished with cutting blades attacking the hairs from different angles. An optimum angle and arrangement of blades is not achieved.

While such conventional razor blade heads produce the result of a shave, a razor head having improved efficiency and convenience is needed.

### SUMMARY

The present invention is a new configuration for a manual razor. The razor of the present invention includes a handle and a razor blade head or cartridge. The razor blade head includes one or more razor blades. The one or more razor blades are oriented diagonally with respect to the top or bottom edge of the razor blade head, or perpendicularly to the handle. This orientation is understood to be within a surface plane of the razor head.

It is a fact that cutting edges work most efficiently when they are at an angle with respect to the direction of motion when used to cut. Blades which are at an angle of 45 degrees with respect to the direction of motion are most efficient. This is sometimes referred to as Kesa Giri, or the Samarai technique. Thus, by orienting razor blades at an angle with respect to the direction of motion, a cleaner and more efficient cut is achieved.

Thus, various embodiments of the present invention include one or more blades oriented diagonally with respect to the direction of motion. In various embodiments, the razor blades are oriented at or substantially at a 45 degree angle with respect to the edges of the razor blade head, and thus to the direction of motion in use.

Ideally, the razor blade head includes a moisturizing strip at the top edge to moisturize the skin to reduce irritation. Preferably, the blades are parallel to one another. Any number of blades may be included. Preferably, blades are evenly spaced apart and applied throughout the razor blade head.

In various preferred embodiments, the razor head includes a horizontal trimming blade. This allows a straight line trimming to be achieved, such as for the bottom of a sideburn. The diagonal blades are thus diagonal with respect to this horizontal trimming blade.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 shows a perspective view of one embodiment of a razor according to the present invention.

FIG. 2 shows a perspective view of one embodiment of a razor according to the present invention.

FIG. 3 shows a perspective view of one embodiment of a razor according to the present invention.

FIG. 4 shows a perspective view of one embodiment of a razor according to the present invention.

FIG. 5 shows a perspective view of one embodiment of a razor according to the present invention.

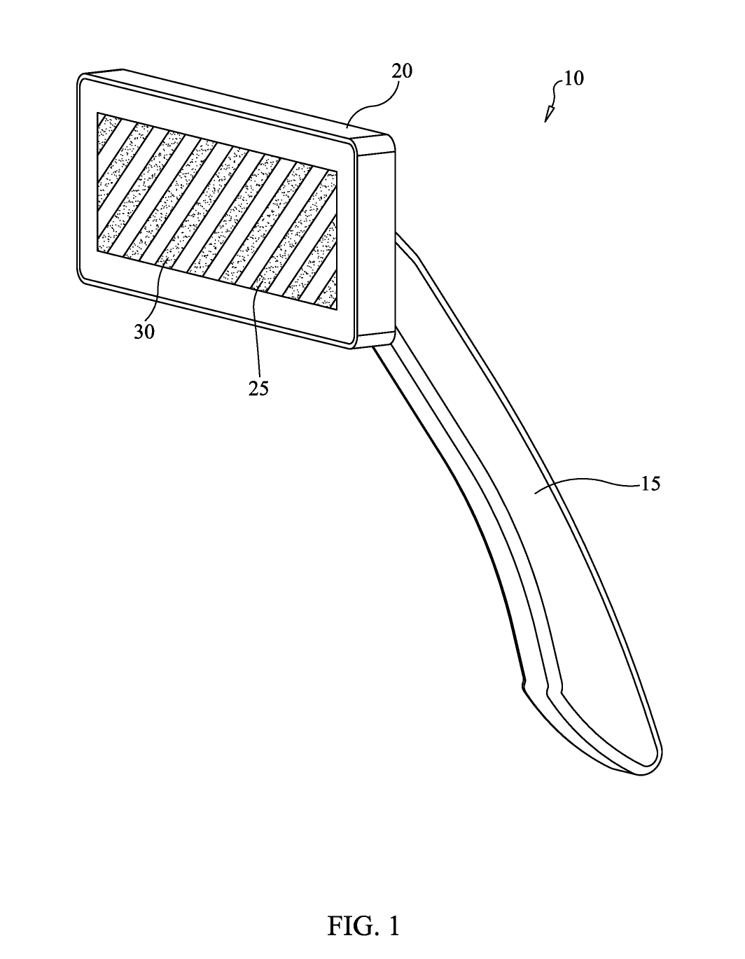

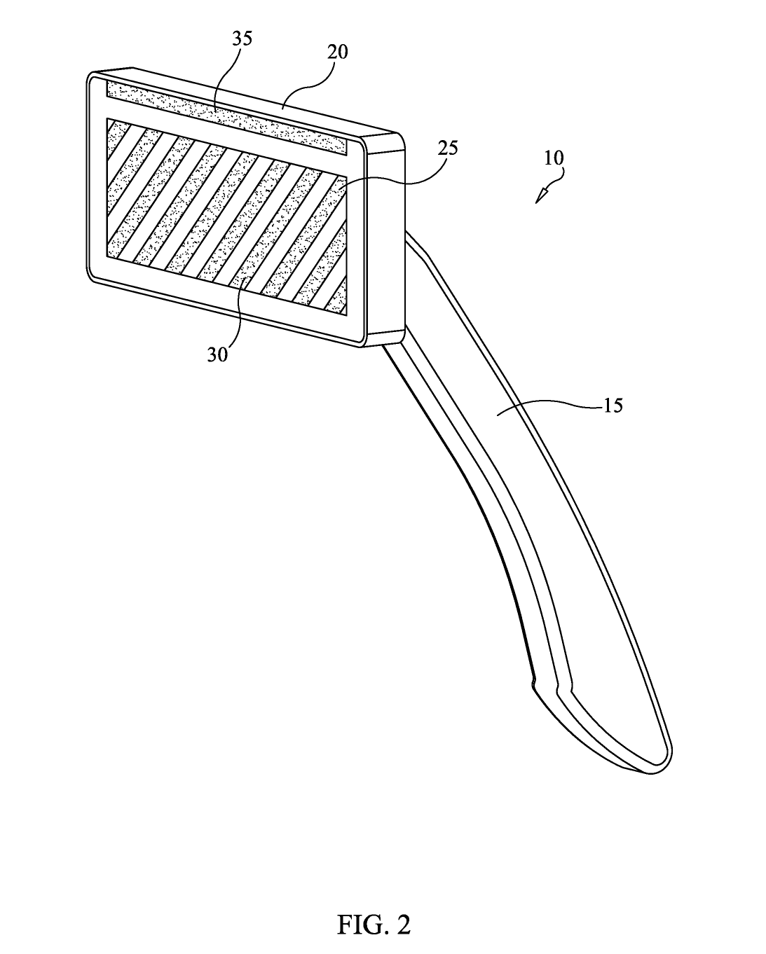

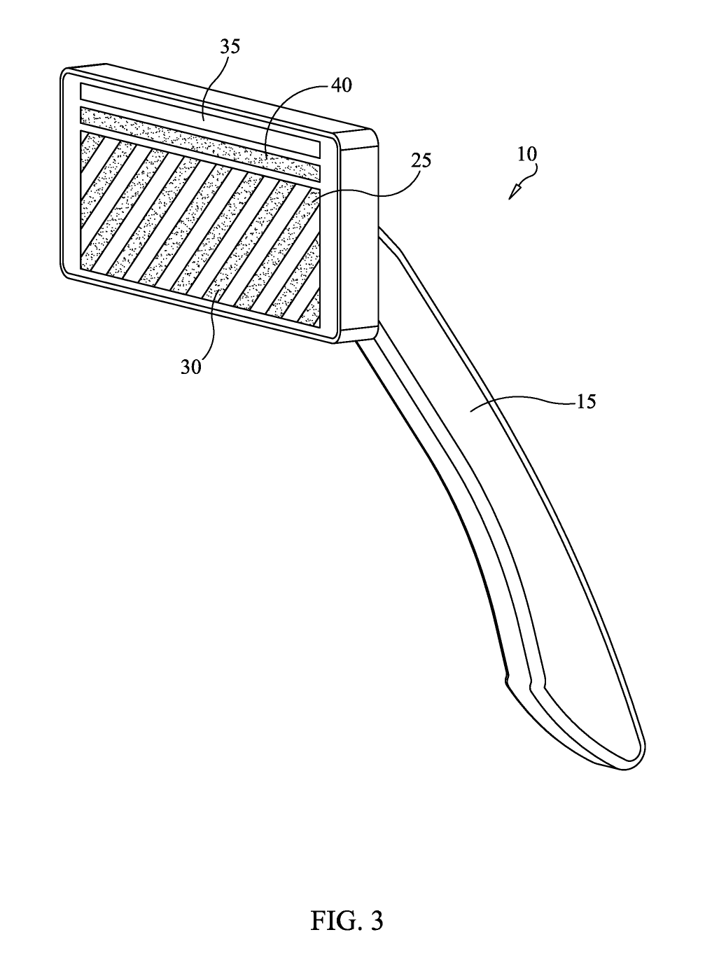

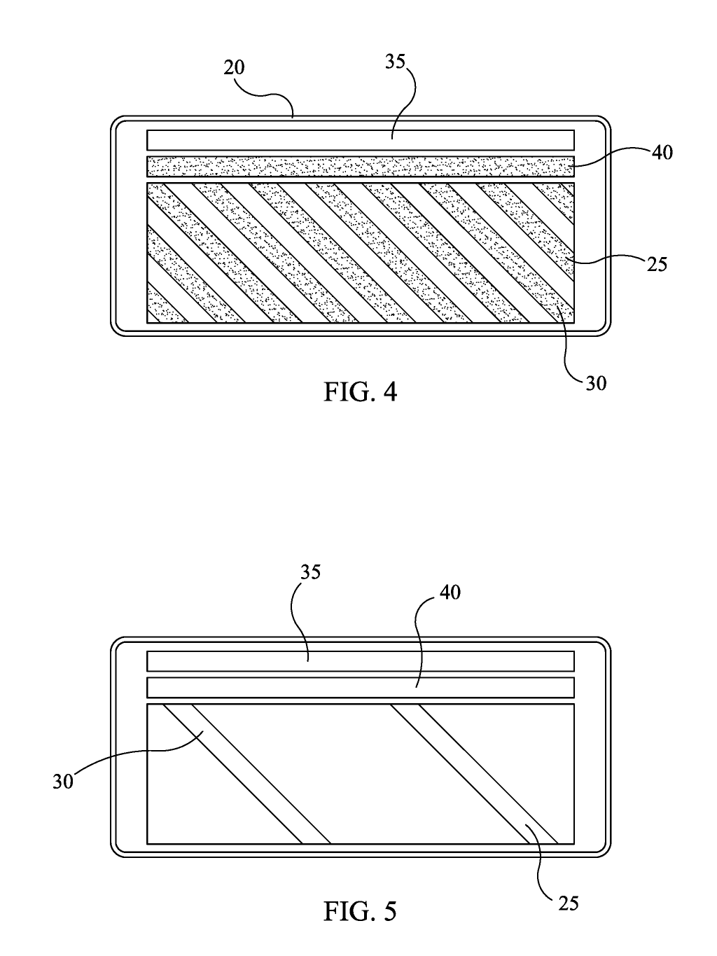

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention includes a manual razor 10. The razor 10 includes a handle 15 and a razor head or cartridge 20. The razor head 20 includes a top and bottom edge, preferably substantially parallel to one another. The razor head 20 includes at least a first razor blade 25, the length of which is disposed along a diagonal angle with respect to the bottom or top edge of the razor head 20 within a surface plane. This orientation is such that the length of the razor blade is positioned diagonally with respect to the direction of motion of the razor blade when in use. Thus, it may be diagonally positioned with respect to the handle 15, or with respect to any appropriate portion of the razor such that the result is that it is positioned diagonally with respect to the direction of motion when in use.

In various embodiments, a second razor blade 30 is included. The second blade 30 is also positioned at a diagonal angle as described above. Ideally, the first and second blades are parallel to one another. In various preferred embodiments, multiple blades, such as 3, 4, 5, or more blades are included, all substantially parallel to one another and diagonally positioned as described above.

Optionally, the razor head 20 of the present invention includes a moisturizing strip 35. The moisturizing strip 35 may be positioned adjacent the top edge of the razor head 20.

In various embodiments, the angle of the positioned of the blades described above is at, substantially at, or close to 45 degrees. Thus, the length of the blades is positioned at such an angle with respect to the direction of motion of the blades when in use.

In certain preferred embodiments, the razor head 20 of the present invention includes a trimming razor blade 40 disposed horizontally within said razor head, and at least a first diagonal razor blade 25 disposed along a diagonal angle with respect to the trimming razor blade. Multiple diagonal blades 25 parallel to one another are optionally included, such as two, three, or more such blades 25.

In such an embodiment having a horizontal blade 40 and multiple diagonal blades 25, a moisturizing strip 35 is optionally disposed parallel to the horizontal blade 40. Ideally, diagonal blades 25 are disposed at substantially 45 degree angles with respect to the trimming razor blade 40.

While specific embodiments have been illustrated and described, numerous modifications come to mind without significantly departing from the spirit of the invention and the scope of protection is limited by the scope of the accompanying claims.

What is claimed is:

1. A razor comprising:
a razor head having a top edge and a bottom edge,
at least a first razor blade disposed along a diagonal angle with respect to the bottom edge of said razor head within a surface plain.

2. The razor according to claim 1, further comprising at least a second razor blade disposed along a diagonal angle with respect to the bottom edge of said razor head, said second razor blade being parallel to said first razor blade.

3. The razor according to claim 2, further comprising a moisturizing strip disposed adjacent the top edge of said razor head.

4. The razor according to claim 2, further comprising at least a third razor blade disposed along a diagonal angle with respect to the bottom edge of said razor head, said third razor blade being parallel to said first razor blade and said second razor blade.

5. The razor according to claim 4, wherein said first, second, and third razor blades are disposed at substantially a 45 degree angle with respect to said bottom edge.

6. A razor comprising:
a handle having,
a cartridge head,
at least a first razor blade disposed in said cartridge head, wherein said first razor blade is disposed at a diagonal angle within a surface plane with respect to said handle.

7. The razor according to claim 6, further comprising at least a second razor blade disposed along a diagonal angle with respect to said handle, said second razor blade being parallel to said first razor blade.

8. The razor according to claim 7, further comprising at least a third razor blade disposed along a diagonal angle with respect to said handle, said third razor blade being parallel to said first razor blade and said second razor blade.

9. The razor according to claim 7, wherein said first, second, and third razor blades are disposed at substantially a 45 degree angle with respect to said bottom edge.

10. The razor according to claim 9, further comprising a moisturizing strip disposed adjacent an edge of said cartridge head.

11. A razor comprising:
a razor head,
a trimming razor blade disposed horizontally within said razor head,
at least a first diagonal razor blade disposed along a diagonal angle with respect to said trimming razor blade.

12. The razor according to claim 11, further comprising at least a second diagonal razor blade disposed along a diagonal angle with respect to said trimming razor blade, said second diagonal razor blade being parallel to said first diagonal razor blade.

13. The razor according to claim 12, further comprising a moisturizing strip disposed parallel to said trimming razor blade along a top region of said razor head.

14. The razor according to claim 12, further comprising at least a third diagonal razor blade disposed along a diagonal angle with respect to said trimming razor blade, said third diagonal razor blade being parallel to said first diagonal razor blade and said second diagonal razor blade.

15. The razor according to claim 14, wherein said first, second, and third diagonal razor blades are disposed at substantially 45 degree angles with respect to said trimming razor blade.
